(19) United States
(12) Patent Application Publication
(10) Pub. No.: US 2006/0259428 A1
(43) Pub. Date: Nov. 16, 2006

(54) Method of providing personal characteristics analysis via network and the system therefor

(76) Inventors: Shen Chang Tseng, Taipei (TW); Hsieh Ji Wei, Taipei (TW)

Correspondence Address: SHEN CHANG TSENG, 235 Chung-Ho, Box 8-24, Taipei, TW

(21) Appl. No.: 11/124,955

(22) Filed: May 10, 2005

(51) Int. Cl. G06F 17/60

(52) U.S. Cl. 705/50

(57) ABSTRACT

In a method of providing personal characteristics analysis via network, a personal characteristics analyzing system is provided. When a company using the personal characteristics analyzing system receives emails from a network manpower bank providing applicants' resumes and information, an automatic forwarding function is actuated at the user end to forward the applicants' emails to the personal characteristics analyzing system for analyzing. Analyzed results are fed back to the user separately or in a batch. Alternatively, the user may inquire the analyzed results of the applicants' personal characteristics via network.

### FIELD OF THE INVENTION

The present invention relates to a personal characteristics analyzing system, and more particularly to a personal characteristics analyzing system that provides personal characteristics analysis via network. The present invention also relates a method of providing personal characteristics analysis via network.

### BACKGROUND OF THE INVENTION

Since information can be advantageously transmitted via network at high speed and low cost, various kinds of services via network have been prosperously developed, and various kinds of information can be very conveniently transferred via network, too. In recent years, it is very popular to apply for a job or find a competent worker via a network manpower bank. The personnel department of a big company would usually subscribe to a network manpower bank's newsletter, so as to get information about desired persons. Similarly, most persons looking for a job would publish their resumes on the web pages of one or more network manpower banks, or email resumes to the personnel departments of companies that have positions suitable for or attracting the applicants. On the other hand, since the network manpower bank provides convenient ways of exchanging information between personal applicants and companies looking for right persons, there might be thousands of emails of application received by the personnel department every day during the period of looking for competent workers. It is a big burden for the personnel department to locate the right persons from thousands of applications.

The personnel department usually handles the thousands of applications received via emails in a two-stage screening way. In the first stage, the applicants are screened based on preset special requirements, such as the school from which the applicant graduated, the highest degree the applicant has obtained, and the applicant's age. Applicants who do not satisfy the requirements are screened out. In the second stage, the applicants selected in the first stage are further screened through interviews. The following problems are found in the above-mentioned mode of interaction between the businesses and manpower banks:
1. As a matter of fact, different jobs need persons of different personal characteristics. However,in the two-stage screening way, the screening in the first stage based on the applicant's school, degree, age, and working experiences fails to take the applicant's personal characteristics into consideration. The applicant's personal characteristics can be primarily understood only in the interview in the second stage of screening. The qualified applicant in the interview might still resign the job within a short time after taking the job. This is an undesired waste in time and cost for both the business and the applicant.
2. For a person who does not graduate from the most famous school or does not have the required high degree, there is almost not any chance of interview in the second screening stage of the existing two-stage screening way. This is unfair to the applicant who is completely excluded from the chance of being trained in a right job, and a loss to the business that fails to find a right person with required personal characteristics for a right job.

It is therefore an important issue to provide effective analysis of applicant's personal characteristics for the businesses looking for right persons, so that the businesses may efficiently and accurately find the competent persons, while the applicants may have fair and proper chances to find a suitable job in a right company.

### SUMMARY OF THE INVENTION

A primary object of the present invention is to provide a method and system for providing personal characteristics analysis via network. When a company using the personal characteristics analyzing system receives emails from a network manpower bank providing applicants' resumes and information, an automatic forwarding function is actuated at the user end to forward the applicants' emails to the personal characteristics analyzing system for analyzing. Analyzed results are fed back to the company using the system separately or in a batch. Alternatively, the company may inquire the analyzed results of the applicants' personal characteristics via network.

Another object of the present invention is to provide a method and system for providing personal characteristics analysis via network, which helps the personnel department or the manpower resource department of a company to handle thousands of applications and analyze the personal characteristics of applicants within a fixed period of time, and allows the company to inquire via network the analyzed results of personal characteristics of applicants within a fixed period of time, so that the company could efficiently find right persons for different positions in the company.

A further object of the present invention is to provide a method and system for providing personal characteristics analysis via network, which helps the personnel department or the manpower resource department of a company to handle thousands of applications and analyze the personal characteristics of applicants within a fixed period of time, and allows the company to inquire via network the analyzed results of personal characteristics of applicants within a fixed period of time. The system for providing personal characteristics analysis via network also provides proper storage and management of the analyzed results of applicants' personal characteristics in a databank, so that a user may inquire the analyzed information about the applicants' personal characteristics via network depending on actual need. In this manner, the manpower resource department does not need to store information of individual applicants and save the space of disk for storing such information.

A still further object of the present invention is to provide a method and system for providing personal characteristics analysis via network, which helps the personnel department or the manpower resource department of a company to handle thousands of applications and analyze the personal characteristics of applicants within a fixed period of time, and allows the company to inquire via network the analyzed results of personal characteristics of applicants within a fixed period of time. The system for providing personal characteristics analysis via network provides proper storage and management of the analyzed results of applicants' personal characteristics in a databank, so that a user may inquire the analyzed information about the applicants' personal characteristics via network depending on actual need. The system for providing personal characteristics analysis via network also provides sufficient authentication and security mechanism, as well as safe backup and management of the applicants' information in the databank, so that the manpower resource department of a company does not need to worry about any unauthorized disclosure or unexpected damage or loss of the applicants' information.

In an embodiment of the personal characteristics analyzing system of the present invention, there are included an authenticating unit, a receiving unit, a transmitting unit, an analyzing and processing unit, and a memory unit. A user transmits the applicants' information to the authenticating unit, at where the user's authority of using the system is authenticated. After a successful authentication, the receiving unit receives the transmitted applicants' information. The received information is analyzed and processed at the analyzing and processing unit, and any analyzed result of the applicants' personal characteristics is stored in the memory unit, which allows the user to inquire the analyzed results. The applicants' information that has been analyzed by the system is transmitted to the user end by the transmitting unit. The analyzed results are fed back to the user by the transmitting unit separately or in a batch. Alternatively, the user may inquire the analyzed results of the applicants' personal characteristics via network.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual view of a system for providing personal characteristics analysis via network according to a first embodiment of the present invention;

FIG. 2 is a flowchart showing steps included in a method of providing personal characteristics analysis via network according to a first embodiment of the present invention;

FIG. 3 is a conceptual view of a system for providing personal characteristics analysis via network according to a second embodiment of the present invention; and

FIG. 4 is a flowchart showing the steps included in a method of providing personal characteristics analysis via network according to a second embodiment of the present invention.

### DETAILED DESCRIPTION OF THE PREFERRED EMBODIMENTS

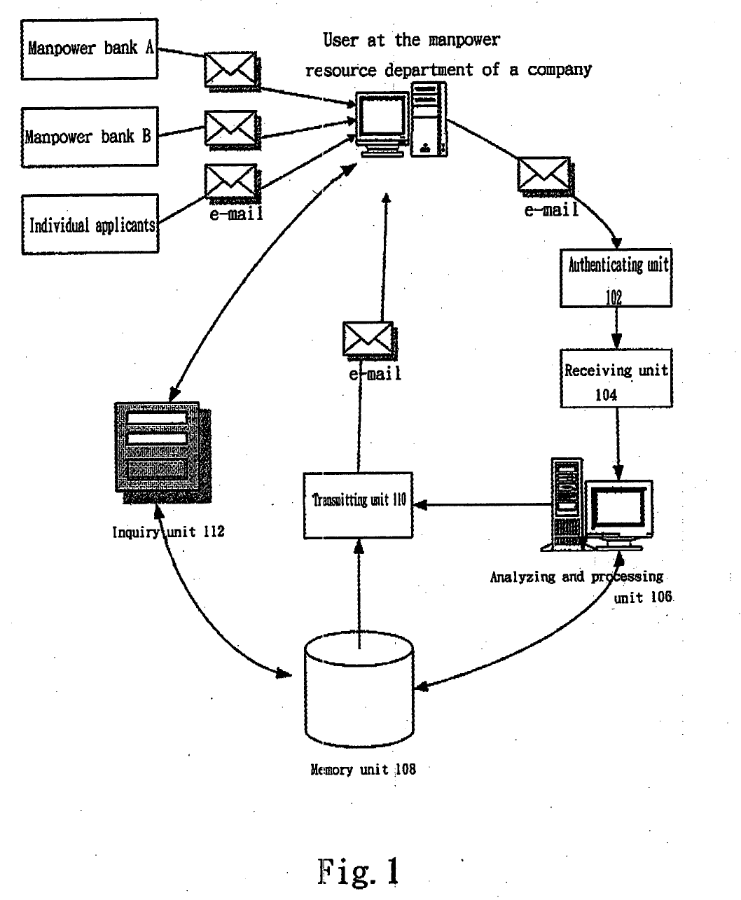

Please refer to FIG. 1 that is a conceptual view of a personal characteristics analyzing system according to a first embodiment of the present invention for providing personal characteristics analysis via network. As shown, the system includes an authenticating unit 102, a receiving unit 104, an analyzing and processing unit 106, a memory unit 108, a transmitting unit 110, and an inquiry unit 112. A company using the personal characteristics analyzing system of the present invention receives from one or more network manpower banks emails providing applicants' information. The emails may be in the form of an electronic resume provided by the manpower bank, or contain information about an applicant's education and employment listed in a specified form, or have an electronic document attached thereto. When the user, that is, the company using the personal characteristics analyzing system of the present invention, receives the applicants' emails, the emails are forwarded to the authenticating unit 102 of the personal characteristics analyzing system through an automatic forwarding function actuated at the user end or through an active forwarding by the user. At the authenticating unit 102, the user's authority of using the system is authenticated. The authentication may be conducted based on POP3 (Post Office Protocol Version 3) or IMAP (Internet Message Access Protocol).

The authenticating unit 102 may include a user payment procedure, which may include different ways of payment, such as payment on each use, payment by value-stored cards, monthly payment, etc. When the authenticating unit 102 successfully completes the authentication, the receiving unit 104 receives the applicants' resumes and information, which may include individual applicant's personal information, such as name, birth date, sex, autobiography, education and employment, etc. All the applicants' resumes and information received by the receiving unit 104 are sent to the analyzing and processing unit 106 for further analyzing and processing. The analyzing and processing unit 106 retrieves from each email the applicant's information, such as the applicant's name, birth date, sex, etc., and conducts personal characteristics analysis based on the retrieved information. The analyzing and processing unit 106 analyzes the applicant's autobiography, education, and employment records based on different analyzing theories, including, for example, the study of names, the horoscopy, the constellations, the science of psychology, statistics, etc. When the analysis is completed, the analyzed results are stored in the memory unit 108 and simultaneously sent to the user end via the transmitting unit 110 separately.

An external user may inquire the analyzed results stored in the memory unit 108 via the inquiry unit 112, which provides a user with the remote inquiry function. In this case, the user is allowed to complete the authentication via the authenticating unit 102 from a remote location. When the authentication is completed at the authenticating unit 102, the user may then inquire the analyzed results from the applicant's information via the inquiry unit 112 at the remote location.

The inquiry unit 112 is capable of analyzing the personal characteristics of all applicants within a fixed period of time on the basis of specified personal characteristics, or analyzing the features of the education, employment, and autobiography of all applicants within a fixed period of time on the basis of education and employment. An inquirer may conduct the inquiry according to preset requirements for desired persons. For example, the user may preset conditions to locate persons with high executing ability and high obedience, and further having an education background of college or above. The inquiry unit 112 is able to provide a list of candidates from the applicants satisfying the preset conditions. The list may be presented on a web page and be inquired from a remote location.

The inquiry unit 112 may conduct the inquiry according to the conditions for desired persons preset by the user. For example, the user may preset conditions to locate persons with high executing ability and high obedience, and further having an education background of college or above. The inquiry unit 112 is able to provide a list of candidates from the applicants satisfying the preset conditions, and is programmed to email the user via the transmitting unit 110 lists of persons meeting the inquiry conditions in a batch after a fixed period of time.

The inquiry unit 112 is able to conduct more accurate analysis of the applicant's personal characteristics according to the user's requirements. For example, the user receives a list of applicants satisfying the required personal characteristics from a web page via remote inquiry, and the received list is produced based on a relatively general analyzing. When the user is interested in some of the applicants in the list, the user may select on the inquiry unit 112 to conduct a further analysis, so as to obtain more accurate analyzed results about these applicants' personal characteristics.

The inquiry unit 112 is able to conduct more accurate analysis of the applicant's personal characteristics according on the user's requirements. For example, the user receives a batch of analyzed results of the applicants personal characteristics fed back to the user end, and the received results are produced based on a relatively general analyzing. When the user is interested in some of the applicants in the batch, the user may select on the inquiry unit 112 to conduct a further analysis, so as to obtain more accurate analyzed results about these applicants' personal characteristics.

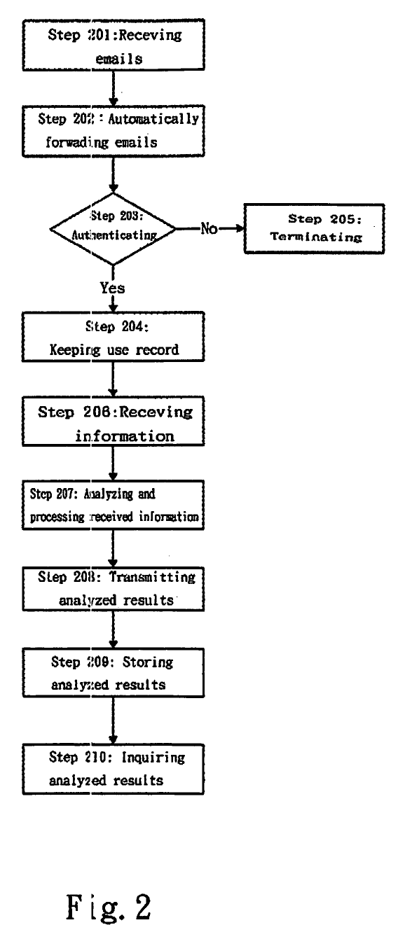

Please refer to FIG. 2 that is a flowchart showing steps included in a method of providing personal characteristics analysis via network according to the first embodiment of the present invention. As shown, in the first step 201 of the method of the present invention, a user receives from one or more network manpower banks emails providing applicants' information. In the second step 202, an email forwarding function is actuated at the user end to forward the received emails about the applicants to a personal characteristics analyzing system for authentication. In the third step 203, the user's authority of using the personal characteristics analyzing system is authenticated. In the fourth step 204, a use record is made after the authentication is successfully completed in the step 203 for use as a basis of requesting payment from the user. The payment may include different payment manners, including payment on each use, payment by value-stored cards, monthly payment, etc. In the event of a failed authentication in the step 203, the method goes to the fifth step 205 and terminates. In the terminating step 205, the information included in the received emails is discarded, or a reply is made to the user to inform the user about the failed authentication. After the use record in the fourth step 204, the method goes to the sixth step 206 and the system starts receiving the applicants' resumes and information. The resume includes the applicant's name, birth date, sex, autobiography, education and employment records, etc. In the seventh step 207, the applicant's information in each email, such as the applicant's name, birth date, etc., is retrieved for personal characteristics analysis. It is also possible to analyze the applicant's autobiography, education, and employment records. Such analysis is conducted based on different theories, such as the study of names, the horoscopy, the constellations, the science of psychology, statistics, etc. Results obtained from the analyzing and processing in the step 207 are transmitted in the eighth step 208, and stored in the ninth step 209.

In the tenth step 210, the user may inquire the analyzed results. In the present invention, the user is allowed to inquire from a remote location. That is, when the user passes the authentication at the remote location, it is allowed to inquire the analyzed results from the remote location in the step 210.

In the inquiry step 210, it is possible to analyze the personal characteristics of all applicants within a fixed period of time on the basis of required personal characteristics, or analyze the features of the education, employment, and autobiography of all applicants within a fixed period of time on the basis of required education and employment. An inquirer may conduct the inquiry according to preset requirements for desired persons. For example, the user may preset conditions to locate persons with high executing ability and high obedience, and further having an education background of college or above. From the inquiry step 210, a list of candidates from the applicants satisfying the preset conditions may be provided. The list may be presented on a web page and be inquired from a remote location.

In the inquiry step 210, it is possible to conduct the inquiry according to the conditions for desired persons preset by the user. For example, the user may preset conditions to locate persons with high executing ability and high obedience, and further having an education background of college or above. From the inquiry step 210, a list of candidates from the applicants satisfying the preset conditions may be provided, and, by way of programming, a batch of lists of persons meeting the inquiry conditions may be transmitted to the user via email after a fixed period of time.

In the inquiry step 210, it is possible to conduct more accurate inquiry of the analyzed results of the applicants' personal characteristics depending on the user's requirements. For example, the user receives a list of applicants satisfying the required personal characteristics from a web page via remote inquiry, and the received list is produced based on a relatively general analyzing. When the user is interested in some of the applicants in the list, the user may select in the inquiry step 210 to conduct a further analysis to obtain more accurate analyzed results about these applicants' personal characteristics.

In the inquiry step 210, it is possible to conduct more accurate inquiry of the analyzed results of the applicants' personal characteristics depending on the user's requirements. For example, the user receives a batch of analyzed results of the applicants' personal characteristics fed back to the user end, and the received results are produced based on a relatively general analyzing. When the user is interested in some of the applicants in the batch, the user may select in the inquiry step 210 to conduct a further analysis to obtain more accurate analyzed results about these applicants' personal characteristics.

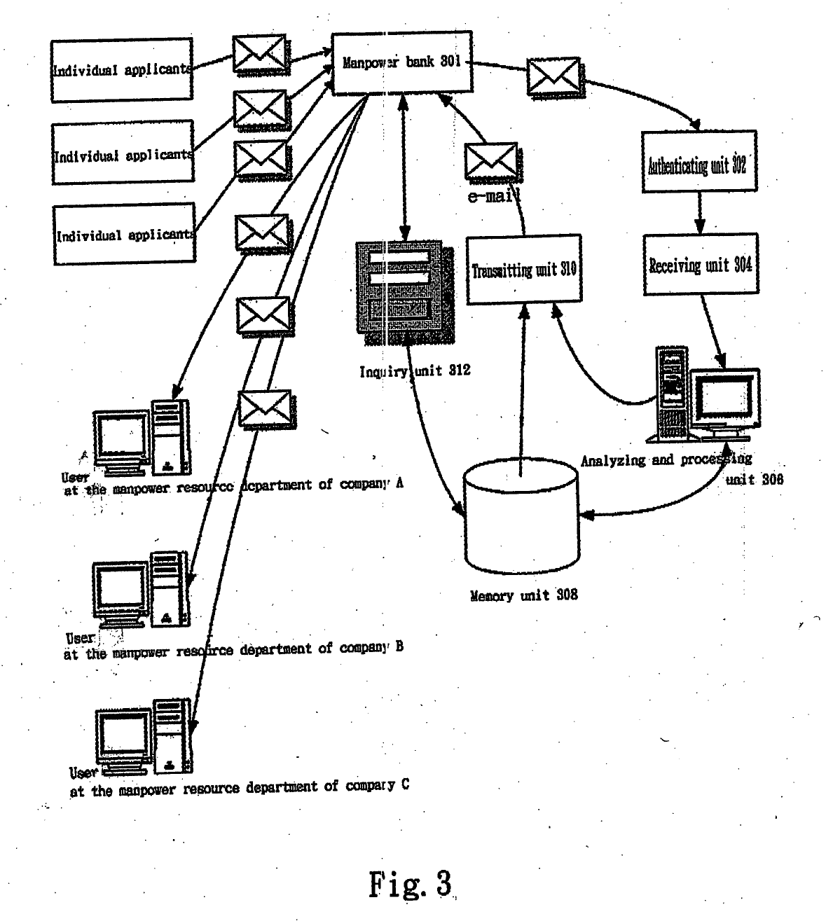

Please refer to FIG. 3 that is a conceptual view of a personal characteristics analyzing system according to a second embodiment of the present invention for providing personal characteristics analysis via network. As shown, the system includes an authenticating unit 302, a receiving unit 304, an analyzing and processing unit 306, a memory unit 308, a transmitting unit 310, and an inquiry unit 312. A network manpower bank 301 using the personal characteristics analyzing system of the present invention receives emails from applicants. The emails may be in the form of an electronic resume provided by the manpower bank, or include information about applicants' education and employment listed in a specified form, or have an electronic document attached thereto. When the network manpower bank 301 receives the applicants' emails, the emails are forwarded to the authenticating unit 302 of the personal characteristics analyzing system through actuating an automatic email forwarding function or through an active forwarding of the emails, and the authenticating unit 302 starts authenticating of the user's authority of using the system. The authentication is conducted based on POP3 or IMAP.

The authenticating unit 302 may include a user payment procedure, which may include different ways of payment, such as payment on each use, payment by value-stored cards, monthly payment, etc. When the authenticating unit 302 completes the authentication successfully, the receiving unit 304 receives the applicants' resumes and information, which may include individual applicant's personal information, such as name, birth date, sex, autobiography, education and employment records, etc. All the applicants' resumes and information received by the receiving unit 304 are sent to the analyzing and processing unit 306 for further analyzing and processing. The analyzing and processing unit 306 retrieves from each email the applicant's information, such as the applicant's name, birth date, sex, etc., and conducts personal characteristics analysis based on the retrieved information. The analysis is conducted based on different analyzing theories, including, for example, the study of names, the horoscopy, the constellations, the science of psychology, statistics, etc. When the analysis is completed, the analyzed results are stored in the memory unit 308 and simultaneously sent to the network manpower bank 301 via the transmitting unit 310 separately.

The network manpower bank 301 may inquire the analyzed results stored in the memory unit 308 via the inquiry unit 312, which provides the network manpower bank 301 with the remote inquiry function. In this case, the network manpower bank 301 is allowed to complete the authentication via the authenticating unit 302 from a remote location. When the authentication is successfully completed at the authenticating unit 302, the network manpower bank 301 may then inquire the analyzed results of the applicant's information via the inquiry unit 312 from the remote location.

The inquiry unit 312 is capable of analyzing the personal characteristics of all applicants within a fixed period of time on the basis of required personal characteristics, or analyzing the features of the education, employment, and autobiography of all applicants within a fixed period of time on the basis of required education and employment records. An inquirer may conduct the inquiry according to preset requirements for desired persons. For example, the network manpower bank 301 may preset conditions to locate persons with high executing ability and high obedience, and further having an education background of college or above. The inquiry unit 312 is able to provide a list of candidates from the applicants satisfying the preset conditions. The list may be presented on a web page and be inquired from a remote location.

The inquiry unit 312 may conduct the inquiry according to the conditions for desired persons preset by the network manpower bank 301. For example, the network manpower bank 301 may preset conditions to locate persons with high executing ability and high obedience, and further having an education background of college or above. The inquiry unit 312 is able to provide a list of candidates from the applicants satisfying the preset conditions, and is programmed to email the network manpower bank 301 via the transmitting unit 310 a batch of lists of persons meeting the inquiry conditions after a fixed period of time.

The inquiry unit 312 is able to conduct more accurate analysis of the applicant's personal characteristics depending on the requirements preset by the network manpower bank 301. For example, the network manpower bank 301 receives a list of applicants satisfying the required personal characteristics from a web page via remote inquiry, and the received list is produced based on a relatively general analyzing. When the network manpower bank 301 is interested in some of the applicants in the list, it may select on the inquiry unit 312 to conduct a further analysis to obtain more accurate analyzed results about these applicants' personal characteristics.

The inquiry unit 312 is able to conduct more accurate analysis of the applicant's personal characteristics depending on the requirements preset by the network manpower bank 301. For example, the network manpower bank 301 receives a batch of analyzed results of the applicants personal characteristics fed back to the user end, and the received results are produced based on a relatively general analyzing. When the network manpower bank 301 is interested in some of the applicants in the batch, it may select on the inquiry unit 312 to conduct a further analysis to obtain more accurate analyzed results about these applicants' personal characteristics.

When the network manpower bank 301 receives separate or a batch of analyzed results emailed by the transmitting unit 310, or obtains a list of persons or applicants satisfying the preset inquiry conditions, the received analyzed results or the obtained lists of suitable persons are forwarded via email to a user at the manpower resource department of a company looking for such persons, so that the manpower resource department of the company may obtain applicants' information that has been analyzed in advance.

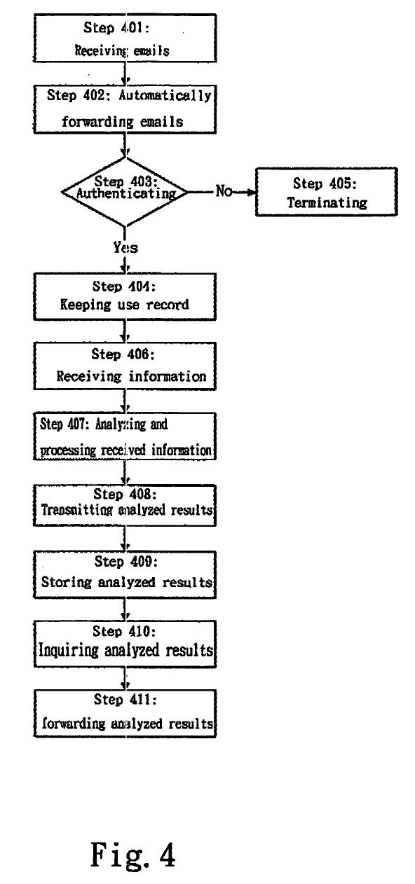

Please refer to FIG. 4 that is a flowchart showing steps included in a method of providing personal characteristics analysis via network according to the second embodiment of the present invention. As shown, in the first step 401 of the method of the present invention, a network manpower bank receives emails from applicants. In the second step 402, an email forwarding function is actuated at the user end to forward the emails received from the applicants to a personal characteristics analyzing system. In the third step 403, the personal characteristics analyzing system authenticates the network manpower bank's authority of using the system. In the fourth step 404, a use record is made after a successful authentication in the step 403 for use as a basis of requesting payment from the network manpower bank. The payment may be made in different ways, including payment on each use, payment by value-stored cards, monthly payment, etc. In the event of a failed authentication in the step 403, the method goes to the fifth step 405 and terminates. In the terminating step 405, the information included in the received email is discarded, or a reply is made to the network manpower bank to inform the latter about the failed authentication. After the use record in the fourth step 404, the method goes to the sixth step 406 and the system starts receiving the applicants' resumes and information which include the individual applicant's name, birth date, sex, autobiography, education and employment, etc. In the seventh step 407, the applicant's information in each email, such as the applicant's name, birth date, etc., is retrieved for personal characteristics analysis. It is also possible to analyze the applicant's autobiography, education, and employment records. Such analysis is conducted based on different theories, such as the study of names, the horoscopy, the constellations, the science of psychology, statistics, etc. Results obtained from the analyzing and processing in the step 407 are transmitted in the eighth step 408, and stored in the ninth step 409.

In the tenth step 410, the network manpower bank may inquire the analyzed results. In the present invention, the network manpower bank is allowed to inquire from a remote location. That is, when the network manpower bank passes the authentication at the remote location, it is allowed to inquire the analyzed results from the remote location in the step 410.

In the inquiry step 410, it is possible to analyze the personal characteristics of all applicants within a fixed period of time on the basis of required personal characteristics, or analyze the features of the education, employment, and autobiography of all applicants within a fixed period of time on the basis of required education and employment. The network manpower bank may conduct the inquiry according to 24. preset requirements for desired persons. For example, the network manpower bank may preset conditions to locate persons with high executing ability and high obedience, and further having an education background of college or above. From the inquiry step 410, a list of candidates from the applicants satisfying the preset conditions may be provided. The list may be presented on a web page and be inquired from a remote location.

In the inquiry step 410, it is possible to conduct the inquiry according to the conditions for desired persons preset by the network manpower bank. For example, the network manpower bank may preset conditions to locate persons with high executing ability and high obedience, and further having an education background of college or above. From the inquiry step 410, a list of candidates from the applicants satisfying the preset conditions may be provided, and, by way of programming, a batch of lists of persons meeting the inquiry conditions may be transmitted to the user via email after a fixed period of time.

In the inquiry step 410, it is possible to conduct a more accurate analysis of the applicant's personal characteristics depending on the requirements preset by the network manpower bank. For example, the network manpower bank receives a list of applicants satisfying the required personal characteristics from a web page via remote inquiry, and the received list is produced based on a relatively general analyzing. When the network manpower bank is interested in some of the applicants in the list, it may select in the inquiry step 410 to conduct a further analysis to obtain more accurate analyzed results about these applicants' personal characteristics.

In the inquiry step 410, it is possible to conduct a more accurate analysis of the applicant's personal characteristics depending on the requirements preset by the network manpower bank. For example, the network manpower bank receives a batch of analyzed results of the applicants' personal characteristics fed back to the user end, and the received results are produced based on a relatively general analyzing. When the network manpower bank is interested in some of the applicants in the batch, it may select in the inquiry step 410 to conduct a further analysis to obtain more accurate analyzed results about these applicants' personal characteristics.

In the eleventh step 411, the analyzed results emailed to the network manpower bank separately or in batch in the step 408, or the lists of persons or applicants satisfying the preset inquiry conditions obtained by the network manpower bank in the step 410 are forwarded via email to a user at the manpower resource department of a company looking for such persons, so that the manpower resource department of the company may obtain applicants' information that has been analyzed in advance.

The personal characteristics analyzing system of the present invention not only provides an efficient and accurate screening way for businesses to get the desired persons, but also provides fair and proper opportunities for all applicants. Therefore, the system of the present invention enables a business to timely find right person for right positions, and helps every applicant to find a right working place, and is therefore an invention highly beneficial to the whole society. The same architecture may be employed on, for example, a matchmaker website, a social website, etc. The matchmaker or social website may email a list of matching persons to the personal characteristics analyzing system of the present invention, and the system conducts a personal characteristics analysis based on the received data and provides the analyzed results to the matchmaker or the social website as a reference, so that the latter may screen right persons and recommend them to other matching persons. The system of the present invention may also be used to filter out any person who is seeking for friends but has potential problems in personality.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A method of providing personal characteristics analysis via network, comprising the steps of:
a. receiving resumes, in which a user of said method receives applicants' resumes and information;
b. forwarding the received resumes and information, in which the applicants' resumes and information are forwarded from the user end to a personal characteristics analyzing system;
c. authenticating, in which the user's authority of using said personal characteristics analyzing system is authenticated;
d. recording the use of said personal characteristics analyzing system by the user, so that a use record is kept as a basis of requesting payment from the user;
e. receiving forwarded information, in which applicants' resumes and information forwarded to the personal characteristics analyzing system by the user are received;
f. analyzing and processing, in which information in each applicant's resume is retrieved for analyzing and processing;
g. transmitting analyzed results, in which results from the analysis in the step f are transmitted to the user;
h. storing the analyzed results, in which the analyzed results obtained in the step f are stored in a predetermined location; and
i. inquiring analyzed results, in which the user is allowed to inquire the analyzed results from a remote location.

2. The method of providing personal characteristics analysis via network as claimed in claim 1, wherein the applicants' resumes and information are provided via network manpower banks.

3. The method of providing personal characteristics analysis via network as claimed in claim 1, wherein the applicants' resumes and information are provided in a specified form.

4. The method of providing personal characteristics analysis via network as claimed in claim 1, wherein the applicants' resumes and information are in the form of an email.

5. The method of providing personal characteristics analysis via network as claimed in claim 1, wherein the applicants' resumes and information are in the form of an electronic document.

6. The method of providing personal characteristics analysis via network as claimed in claim 1, wherein, in the step b of forwarding received resumes, the received resumes are forwarded to said personal characteristics analyzing system in a manner selected from the group consisting of being actively forwarded by the user, and being automatically forwarded through a setting of said personal characteristics analyzing system.

7. The method of providing personal characteristics analysis via network as claimed in claim 1, wherein, in the step c of authenticating, the user's authority of using said personal characteristics analyzing system is authenticated based on POP3 (Post Office Protocol Version 3) and/or IMAP (Internet Message Access Protocol).

8. The method of providing personal characteristics analysis via network as claimed in claim 1, wherein, in the step f of analyzing and processing, the information retrieved from each applicant's resume for analyzing includes the applicant's name, birthday, sex, autobiography, and education and employment records.

9. The method of providing personal characteristics analysis via network as claimed in claim 1, wherein, in the step f of analyzing and processing, the information retrieved from each applicant's resume for analyzing is analyzed based on different analyzing theories, including the study of names, the horoscopy, the constellations, the science of psychology, and statistics.

10. The method of providing personal characteristics analysis via network as claimed in claim 1, wherein, in the step g of transmitting analyzed results, the analyzed results are transmitted in a manner selected from the group consisting of being separately transmitted to the user via email, and being transmitted to the user via email in a batch.

11. The method of providing personal characteristics analysis via network as claimed in claim 1, wherein, in the step i of inquiry, the user presets inquiry conditions to inquire analyzed results from all applicants within a fixed period of time.

12. The method of providing personal characteristics analysis via network as claimed in claim 1, wherein, in the step i of inquiry, the user receives a batch of analyzed results of personal characteristics fed back to the user end, and the user is allowed to inquire more accurate analyzed results of personal characteristics via the inquiry step i by presetting more accurate inquiry conditions for further analyzing.

13. The method of providing personal characteristics analysis via network as claimed in claim 1, wherein, in the step i of inquiry, the user receives a batch of analyzed results of applicants' education and employment records fed back to the user end.

14. A method of providing personal characteristics analysis via network, comprising the steps of:
a. receiving resumes, in which a network manpower bank receives applicants' resumes and information;
b. forwarding the received resumes and information, in which the applicants' resumes and information are forwarded from the network manpower bank to a personal characteristics analyzing system;
c. authenticating, in which the network manpower bank's authority of using said personal characteristics analyzing system is authenticated;
d. recording the use of said personal characteristics analyzing system by the network manpower bank, so that a use record is kept as a basis of requesting payment from the network manpower bank;
e. receiving forwarded information, in which applicants' resumes and information forwarded to said personal characteristics analyzing system by the network manpower bank is received;
f. analyzing and processing, in which information in the applicants' resumes is retrieved for analyzing;
g. transmitting analyzed results, in which results from the analysis in the step f are transmitted to the network manpower bank;
h. storing the analyzed results, in which the analyzed results obtained in the step f are stored in a predetermined location;
i. inquiring analyzed results, in which the network manpower bank is allowed to inquire the analyzed results from a remote location; and
j. forwarding the analyzed resumes, in which the network manpower bank forwards via email the applicants' resumes, which have been analyzed by said personal characteristics analyzing system, to different companies that are looking for right persons for right positions.

15. The method of providing personal characteristics analysis via network as claimed in claim 14, wherein the applicants' resumes and information are provided in a specified form.

16. The method of providing personal characteristics analysis via network as claimed in claim 14, wherein the applicants' resumes and information are in the form of an email.

17. The method of providing personal characteristics analysis via network as claimed in claim 14, wherein the applicants' resumes and information are in the form of an electronic document.

18. The method of providing personal characteristics analysis via network as claimed in claim 14, wherein, in the step b of forwarding received resumes, the received resumes and information are forwarded to said personal characteristics analyzing system in a manner selected from the group consisting of being actively forwarded by the network manpower bank, and being automatically forwarded through a setting of said personal characteristics analyzing system.

19. The method of providing personal characteristics analysis via network as claimed in claim 14, wherein, in the step c of authenticating, the network manpower bank's authority of using said personal characteristics analyzing system is authenticated based on POP3 (Post Office Protocol Version 3) and/or IMAP (Internet Message Access Protocol).

20. The method of providing personal characteristics analysis via network as claimed in claim 14, wherein, in the step f of analyzing and processing, the information retrieved from each applicant's resume for analyzing includes the applicant's name, birthday, sex, autobiography, and education and employment records.

21. The method of providing personal characteristics analysis via network as claimed in claim 14, wherein, in the step f of analyzing and processing, the information retrieved from each applicant's resume for analyzing is analyzed based on different analyzing theories, including the study of names, the horoscopy, the constellations, the science of psychology, and statistics.

22. The method of providing personal characteristics analysis via network as claimed in claim 14, wherein, in the step g of transmitting analyzed results, the analyzed results are transmitted in a manner selected from the group consisting of being separately transmitted to the network manpower bank via email, and being transmitted to the network manpower bank via email in a batch.

23. The method of providing personal characteristics analysis via network as claimed in claim 14, wherein, in the step i of inquiry, the network manpower bank presets inquiry conditions to inquire analyzed results from all applicants within a fixed period of time.

24. The method of providing personal characteristics analysis via network as claimed in claim 14, wherein, in the step i of inquiry, the network manpower bank receives a batch of analyzed results of personal characteristics fed back to the network manpower bank, and the network manpower bank is allowed to inquire more accurate analyzed results of personal characteristics via the inquiry step i by presetting more accurate inquiry conditions for further analyzing.

25. The method of providing personal characteristics analysis via network as claimed in claim 14, wherein, in the step i of inquiry, the network manpower bank receives a batch of analyzed results of applicants' education and employment records fed back to the user end.

26. A personal characteristics analyzing system for providing personal characteristics analysis via network, comprising:
an authenticating unit for authenticating a user's authority of using said system;
a receiving unit for receiving applicants' resumes;
an analyzing and processing unit for retrieving and analyzing information in the received applicants' resumes;
a transmitting unit for transmitting analyzed results from the analyzing and processing unit to the user;
a memory unit for storing the analyzed results from the analyzing and processing unit; and
an inquiry unit for a user to inquire the analyzed results from a remote location.

27. The personal characteristics analyzing system as claimed in claim 26, wherein the authenticating unit conducts the authentication based on POP3 (Post Office Protocol Version 3) and/or IMAP (Internet Message Access Protocol).

28. The personal characteristics analyzing system as claimed in claim 26, wherein the authenticating unit includes a use record procedure for keeping a use record of using said system as a basis of requesting payment from the user.

29. The personal characteristics analyzing system as claimed in claim 26, wherein the applicants' resumes and information are provided via a network manpower bank.

30. The personal characteristics analyzing system as claimed in claim 26, wherein the applicants' resumes and information are provided in a specified form.

31. The personal characteristics analyzing system as claimed in claim 26, wherein the applicants' resumes and information are in the form of an email.

32. The personal characteristics analyzing system as claimed in claim 26, wherein the applicants' resumes and information are in the form of an electronic document.

33. The personal characteristics analyzing system as claimed in claim 26, wherein the analyzing and processing unit automatically retrieves information about the applicant's name, birthday, sex, autobiography, and education and employment records from each applicant's resume for analyzing.

34. The personal characteristics analyzing system as claimed in claim 26, wherein the analyzing and processing unit analyzes the information retrieved from each applicant's resume based on different analyzing theories, including the study of names, the horoscopy, the constellations, the science of psychology, and statistics.

35. The personal characteristics analyzing system as claimed in claim 26, wherein the transmitting unit transmits the analyzed results in a manner selected from the group consisting of separately transmitting the analyzed results of each applicant's resume to the user via email, and transmitting the analyzed results of more than one applicant's resume to the user via email in a batch.

36. The personal characteristics analyzing system as claimed in claim 26, wherein the inquiry unit allows a user to preset personal characteristic requirements for desired persons for inquiring the personal characteristics of all applicants within a fixed period of time.

37. The personal characteristics analyzing system as claimed in claim 26, wherein analyzed results of applicants' personal characteristics are fed back to the user end in a batch by the inquiry unit and received by the user, and the inquiry unit is able to conduct more accurate analysis for the user to inquire more accurate analyzed results of the applicants' personal characteristics.

38. The personal characteristics analyzing system as claimed in claim 26, wherein analyzed results of applicants' education and employment records are fed back to the user end in a batch by the inquiry unit and received by the user.
